(19) United States
(12) Patent Application Publication
(10) Pub. No.: US 2025/0312937 A1
(43) Pub. Date: Oct. 9, 2025

(54) MEDICINE CUTTER WITH BLADE PROTECTION AND POSITIONING STRUCTURE

(71) Applicant: Huizhou Yixiang Technology Co., Ltd., Huizhou (CN)

(72) Inventor: MINGYOU WEN, Huaihua (CN)

(21) Appl. No.: 18/647,150

(22) Filed: Apr. 26, 2024

(30) Foreign Application Priority Data
Apr. 7, 2024 (CN) 202420685357.7

(51) Int. Cl. B26D 7/22; A61J 7/00; B26D 1/30; B26D 3/30

(52) U.S. Cl. CPC B26D 7/22; A61J 7/0007; B26D 1/30; B26D 3/30

(57) ABSTRACT

A medicine cutter with a blade protection and positioning structure, including an upper cover, a lower cover, a blade protection cover, a blade, a blocking structure, a guide bump, a receiving structure, and a guide structure. The upper cover and the lower cover are closed together by rotating a hinge, the blade protection cover is located on one side of the blade. The blade protection cover is provided with a torsion spring, an upper end of the blade protection cover is flappable connection to the upper cover through the torsion spring. A guide bump is provided between the blocking structure and the receiving structure, and the blocking structure, the guide bump, and the receiving structure are all provided on the lower cover.

### CROSS-REFERENCE TO RELATED APPLICATIONS

This application claims priority to Chinese Patent Application No. 202420685357.7, filed on Apr. 7, 2024, which is hereby incorporated by reference in its entirety.

### TECHNICAL FIELD

The present disclosure relates to the field of medicine cutter technologies, and in particular, to a medicine cutter with blade protection and positioning structure.

### BACKGROUND

In an actual medication process, tablets are often cut due to dosage, and cross-section of most tablets is circular. The traditional method is to use hands to break and scissors to cut, as the volume of tablets is usually small and the cutting difficulty is high, rendering it difficult to control the cutting effect. Therefore, there are medicine cutters on the market that can easily and conveniently cut tablets. However, the blades of traditional medicine cutters on the market are exposed, and there is no protective structure for the blades. The sharp edges of the blades are easily damaged and cut fingers, with low safety; when the medicine cutter is used for cutting medicine, only left and right deviation is controlled by a rotation axis between upper and lower covers, which can cause a large deviation of the blade away from the rotation axis, reduce the effectiveness of medicine cutting, have low accuracy, and affect the user experience.

Therefore, how to provide a medicine cutter with blade protection and positioning structure is an urgent problem that technical personnel in this field need to solve.

### SUMMARY

The purpose of the present disclosure is to provide a medicine cutter with a blade protection and positioning structure, aiming to solve the above technical problems. The medicine cutter with a blade protection and positioning structure has advantages of high safety, good medicine cutting effect, high accuracy, high stability, convenient use, and strong practicality.

In order to achieve the above objectives, the present disclosure is implemented through the following technical solutions.

A medicine cutter with a blade protection and positioning structure, including an upper cover, a lower cover, a blade protection cover, a blade, a blocking structure, a guide bump, a receiving structure, and a guide structure; the upper cover and the lower cover are covered together by a rotating a hinge, the blade protection cover is located on one side of the blade; the blade protection cover is provided with a torsion spring, an upper end of the blade protection cover is flipped and connected to the upper cover through the torsion spring; the guide bump is provided between the blocking structure and the receiving structure, the blocking structure, guide bump, and receiving structure are all provided on the lower cover; when the upper cover rotates and covers on the lower cover, the blade protection cover slides along the guide bump and flips until it lands on the receiving structure with a cooperation of the torsion spring.

In an embodiment, the guide structure includes an upper guiding seat and a lower guiding seat; the upper guiding seat is symmetrically arranged in the upper cover, and the lower guiding seat is symmetrically arranged in the lower cover; the upper guiding seat is inserted into the lower guiding seat.

In an embodiment, the blocking structure includes a blocking limit seat, a blocking limit portion is provided on the blocking limit seat, and the blocking limit portion is configured to be an arc shape; when the upper cover is opened and closed to a certain angle, one end of the blade protection cover contacts and abuts against the blocking limit portion.

In an embodiment, an upper end of the guide bump is configured to be an inclined state.

In an embodiment, the receiving structure includes a receiving portion and a side end portion, one end of the side end portion is connected to the guide bump position, and the other end thereof is connected to the receiving portion; an upper end of the receiving portion is configured to be an inclined state; when the upper cover rotates and closes on the lower cover, the blade protection cover abuts against the receiving portion.

In an embodiment, the blade protection cover includes a first flipping connection portion, a second flipping connection portion, and a blade protection holder; the first flipping connection portion and the second flipping connection portion are both provided at an upper end of the blade protection holder, and one end of the first flipping connection portion and the second flipping connection portion are movably connected to the upper cover; the torsion spring is installed at the other end of the second flipping connection portion.

In an embodiment, the blade protection holder is in an “L” shape, and includes a vertical protection portion and a horizontal protection portion; the first flipping connection portion and the second flipping connection portion are both connected to the vertical protection portion, and one end of the horizontal protection portion is provided with a limit end portion; when the upper cover is opened and closed at a certain angle, the limit end portion contacts and abuts against the blocking limit portion.

In an embodiment, the upper cover is further provided with a blade installation portion, a first flipping installation portion, and a second flipping installation portion; an upper end of the blade is fixedly installed in the blade installation portion, and the first flipping installation portion and the second flipping installation portion are both located on one side of the blade installation portion; one end of the first flipping connection portion is movably connected to the first flipping installation portion, and one end of the second flipping connection portion is fixedly connected to the second flipping connection portion.

The medicine cutter with a blade protection and positioning structure of the present disclosure has the following beneficial effects:
1. The medicine cutter with a blade protection and positioning structure of the present disclosure, by providing with a blade protection cover and a blocking structure, the blade protection cover can be flipped and returned an original position under a force of a torsion spring and guide bump. When the upper cover is opened, the blade protection cover is returned to the original position for protection under the force of the torsion spring, and the blocking structure blocks the blade protection cover, so that the blade protection cover cannot be flipped, thereby achieving the protection of the blade to avoid cutting hand and damage of blade, with high safety.
2. The medicine cutter with a blade protection and positioning structure of the present disclosure, by providing with the upper guiding seat and lower guiding seat of the guide structure, by the overlapping of two points, that is, when the covers are closed, the upper guiding seat and lower guiding seat are inserted and overlapped for left and right positioning, and thereby precisely controlling left and right deviations. When the upper cover and lower cover are closed, a triangular positioning is formed between the guide structure, a rotation axis between the upper cover and lower cover to achieve center positioning and avoid shaking, which can better control the cutting deviation of the tablet, with high accuracy and stability, having good medicine cutting effect.

### BRIEF DESCRIPTION OF DRAWINGS

FIG. 1 is a schematic diagram of an overall structure of a medicine cutter with blade protection and positioning structure of the present disclosure.

FIG. 2 is a structural schematic diagram of a lower cover shown in FIG. 1.

FIG. 3 is a structural schematic diagram of an upper cover (excluding a blade protection cover) shown in FIG. 1.

FIG. 4 is a structural schematic diagram of the present disclosure in a closed state.

FIG. 5 is a structural schematic diagram without the upper cover shown in FIG. 4.

### DESCRIPTION OF EMBODIMENTS

In order to enable those skilled in this field to better understand the technical solution of the present disclosure, the following is a further detailed explanation of a product of the present disclosure, combined with embodiments and accompanying drawings.

It should be noted that when a component is referred to as “fixed to” another component, it can be directly attached to another component or there can be a mediate component; when a component is considered to be “connected” to another component, it can be directly connected to another component or there may be a mediate component that is present simultaneously. Terms “vertical”, “horizontal”, “left”, “right” and similar expressions used in this specification are for illustrative purposes only and do not imply that they are the only means of implementation.

Unless otherwise defined, all technical and scientific terms used in this specification have the same meanings as those commonly understood by those skilled in the technical field of the present disclosure. Terms used in the specification of the present disclosure are only for a purpose of describing specific embodiment, and are not intended to limit the present disclosure. The term “and/or” used in this specification includes any and all combinations of one or more related listed items.

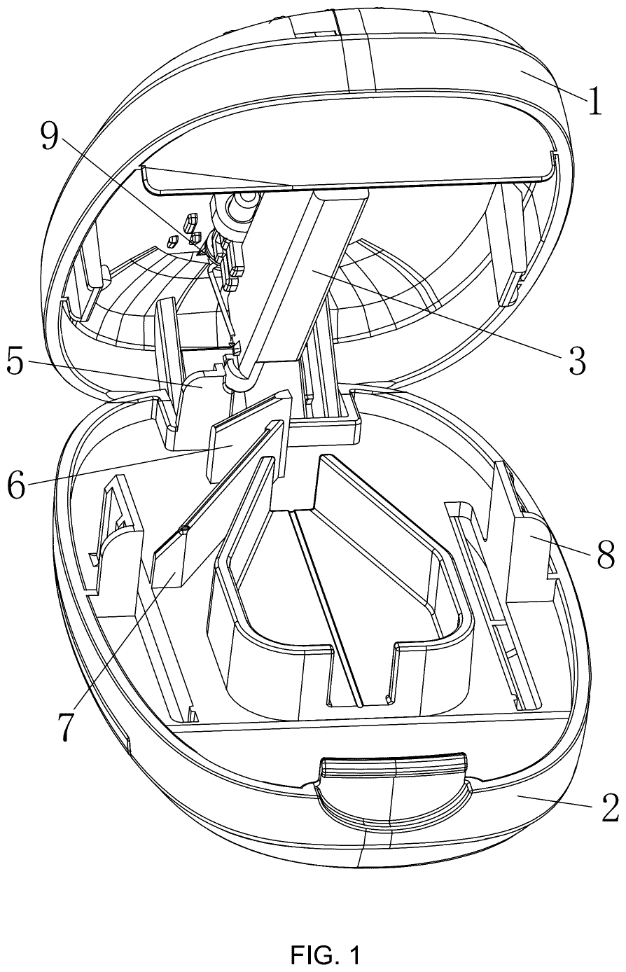

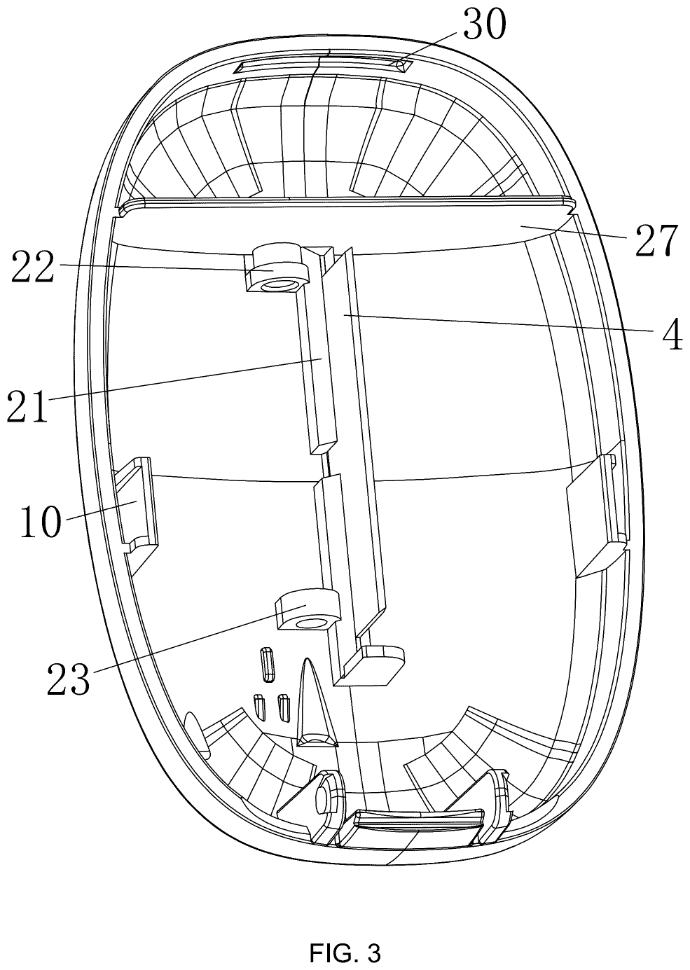

As shown in FIGS. 1 and 3, a medicine cutter with a blade protection and positioning structure includes an upper cover 1, a lower cover 2, a blade protection cover 3, a blade 4, a blocking structure 5, a guide bump 6, a receiving structure 7, and a guide structure 8. The upper cover 1 and the lower cover 2 are covered together by rotating a hinge, the blade protection cover 3 is located on one side of the blade 4. The blade protection cover 3 is provided with a torsion spring 9, an upper end of the blade protection cover 3 is flipped to the upper cover 1 through the torsion spring 9. The blocking structure 5 and the receiving structure 7 are connected to the guide bump 6; the blocking structure 5, the guide bump 6, and the receiving structure 7 are connected by the guide bump 6. The receiving structure 7 is provided on the lower cover 2. When the upper cover 1 rotates and closes on the lower cover 2, the blade protection cover 3 slides along the guide bump 6 and flips with a help of the torsion spring 9 until it lands on the receiving structure 7.

It should be noted that by providing with the blade protection cover 3 and the blocking structure 5, the blade protection cover 3 can be flipped and returned an original position by a force of the torsion spring 9 and the guide bump 6.

When the upper cover 1 is opened, the blade protection cover 3 returns to its original position under the force of the torsion spring 9. At this time, the blocking structure 5 blocks the blade protection cover 3, preventing it from flipping and protecting the blade 4 from damage to cutting hand and blade 4.

When cutting medicine, the blade protection cover 3 leaves the blocking structure 5, and is guided by the guide bump 6 to flip and land on the receiving structure 7.

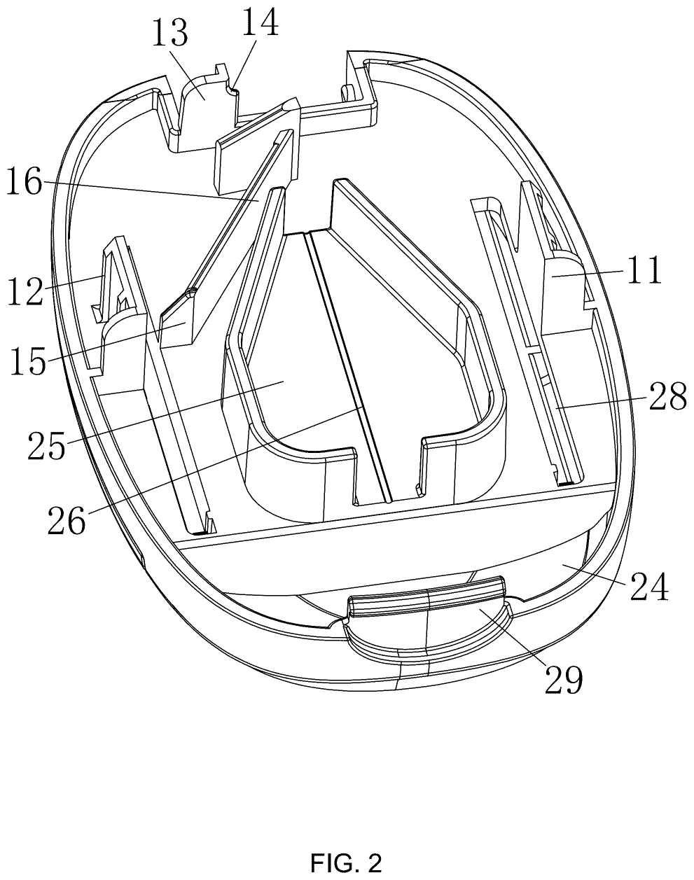

As shown in FIGS. 2 and 3, the guide structure 8 includes an upper guiding seat 10 and a lower guiding seat 11. The upper guiding seat 10 is symmetrically arranged in the upper cover 1, and the lower guiding seat 11 is symmetrically arranged in the lower cover 2. The lower guiding seat 11 is provided with an insertion end 12 inside. When the upper cover 1 rotates and covers on the lower cover 2, the upper guiding seat 10 is inserted into the insertion end 12.

It should be noted that by providing with the upper guiding seat 10 and lower guiding seat 11 of the guide structure 8, when the cover is closed, the upper guiding seat 10 and the lower guiding seat 11 are inserted and overlapped. The present disclosure uses the overlapping of two points, that is, the upper guiding seat 10 and the lower guiding seat 11 are inserted and overlapped so as to achieve left and right positioning, thereby accurately controlling left and right deviation, and form a triangular positioning between the guide structure 8, a rotation axis between upper cover 1, and lower cover 2 when the cover is closed, so as to achieve center positioning and avoid shaking. It can better control the cutting deviation of the tablet, with high accuracy, good stability, and good cutting effect.

As shown in FIG. 2, the blocking structure 5 includes a blocking limit seat 13, which is provided with a blocking limit portion 14. The blocking limit portion 14 is configured to be an arc shape. When the upper cover 1 is opened and closed at a certain angle, one end of the blade protection cover 3 contacts and abuts against the blocking limit portion 14.

As shown in FIG. 2, an upper end of the guide bump 6 is configured to be an inclined state.

As shown in FIG. 2, the receiving structure 7 includes a receiving portion 15 and a side end portion 16. One end of the side end portion 16 is connected to the guide bump 6, and the other end is connected to the receiving portion 15. An upper end of the receiving portion 15 is configured to be an inclined state. When the upper cover 1 rotates and closes on the lower cover 2, the blade protection cover 3 abuts against the receiving portion 15.

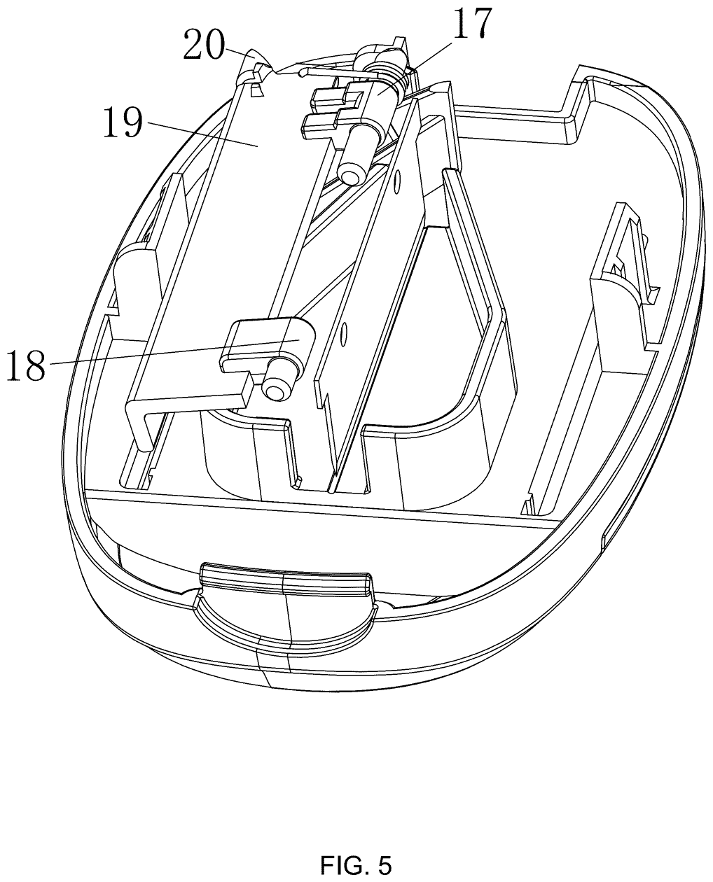

As shown in FIG. 5, the blade protection cover 3 includes a first flipping connection portion 17, a second flipping connection portion 18, and a blade protection holder 19. The first flipping connection portion 17 and the second flipping connection portion 18 are both provided at an upper end of the blade protection holder 19. One end of the first flipping connection portion 17 and the second flipping connection portion 18 are both movably connected to the upper cover 1, and the torsion spring 9 is installed at the other end of the second flipping connection portion 18.

As shown in FIG. 5, the blade protection holder 19 is in an “L” shape, which includes a vertical protection portion and a horizontal protection portion. The first flipping connection portion 17 and the second flipping connection portion 18 are both connected to the vertical protection portion. One end of the horizontal protection portion is provided with a limit end portion 20. When the upper cover 1 is opened and closed at a certain angle, the limit end portion 20 contacts and abuts against the blocking limit portion 14.

As shown in FIG. 2, the upper cover 1 is further provided with a blade installation portion 21, a first flipping installation portion 22, and a second flipping installation portion 23. An upper end of the blade 4 is fixedly installed in the blade installation portion 21, and the first flipping installation portion 22 and the second flipping installation portion 23 are both located on one side of the blade installation portion 21. One end of the first flipping connection portion 17 can be flexibly connected to the first flipping installation portion 22, and one end of the second flipping connection portion 18 can be movably connected to the second flipping connection portion 18.

As shown in FIGS. 2 and 3, the lower cover 2 is further provided with a medicine storage groove 24 and a medicine cutting platform 25 with an opening at two ends. The medicine cutting platform 25 is located on one side of the receiving structure 7, and there is a medicine cutting groove 26 inside the medicine cutting platform 25 for placing to-be-cut medicine. The blade 4 can fall into the medicine cutting groove 26 for cutting medicine. The medicine storage groove 24 is located on one side of the medicine cutting platform 25, and the medicine storage groove 24 is configured to temporarily store the medicine tablets. There is also a baffle 27 inside the upper cover 1. When the cover is closed, the baffle 27 can block the opening of the medicine cutting platform 25 to prevent the medicine tablets from flying out during medicine cutting.

As shown in FIG. 2, there is also a clamp groove 28 inside the lower cover 2. The clamp groove 28 is located on one side of the lower guiding seat 11, and a clamp portion is provided inside the clamp groove 28. A bottom of the lower cover 2 is provided with a detachable bottom cover, there is a fastening component on the bottom cover. The fastening component can be connected to the clamp portion through the clamp groove 28.

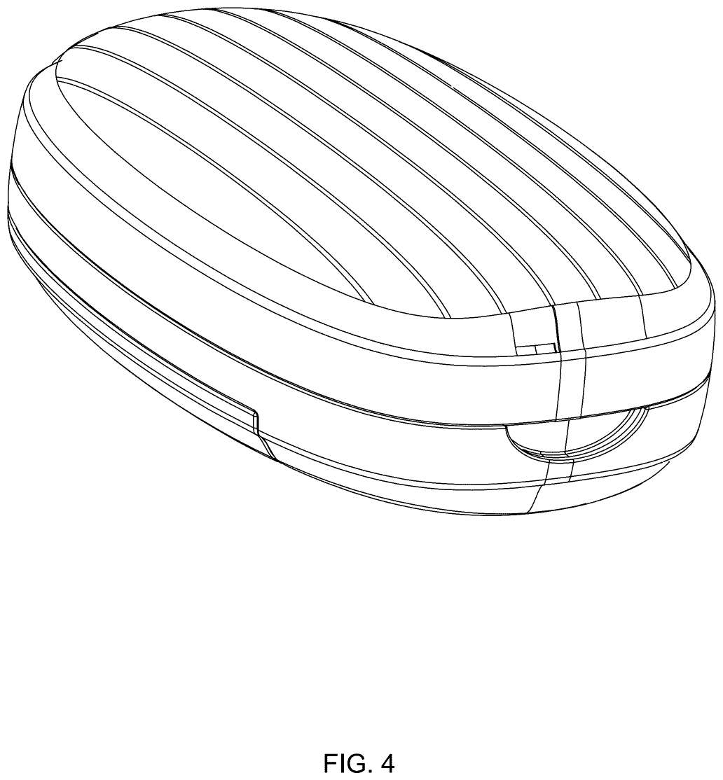

As shown in FIGS. 2 to 4, the lower cover 2 is further provided with a press part 29, and the upper cover 1 is provided with a locking groove 30. An upper end of the press part 29 is adapted to the locking groove 30, and the press part 29 is made of elastic material. When it is necessary to open the upper cover 1, the press part 29 is simply pressed to release an upper end of the press part 29 from the locking groove 30, and the cover can be easily opened.

The above is only a preferred embodiment of the present disclosure and does not impose any limitations on the present disclosure; any ordinary technical personnel in this filed can implement the present disclosure as shown in the attached drawings of the specification and as described above; however, any technical personnel familiar with this field who, without departing from the scope of the technical solution of the present disclosure, can make minor changes, modifications, and evolution equivalent to the technical content disclosed above, are all equivalent embodiments of the present disclosure; meanwhile, any equivalent changes, modifications, and evolution made to the above embodiments based on the substantive technology of the present disclosure shall still fall within the protection scope of the technical solution of the present disclosure.

What is claimed is:

1. A medicine cutter with a blade protection and positioning structure, comprising an upper cover, a lower cover, a blade protection cover, a blade, a blocking structure, a guide bump, a receiving structure, and a guide structure; the upper cover and the lower cover are covered together by a rotating a hinge, the blade protection cover is located on one side of the blade; the blade protection cover is provided with a torsion spring, an upper end of the blade protection cover is flipped and connected to the upper cover through the torsion spring; the guide bump is provided between the blocking structure and the receiving structure, the blocking structure, guide bump, and receiving structure are all provided on the lower cover; when the upper cover is opened, the blade protection cover is returned to an original position under a force of the torsion spring, and the blocking structure blocks the blade protection cover to prevent it from flipping;
the guide structure comprises an upper guiding seat and a lower guiding seat; the upper guiding seat is symmetrically arranged in the upper cover, and the lower guiding seat is symmetrically arranged in the lower cover; the upper guiding seat is inserted into the lower guiding seat; when the upper cover rotates and covers on the lower cover, left and right positioning is achieved by inserting and overlapping between the upper guiding seat and the lower guiding seat so as avoid shaking; at the same time, the blade protection cover leaves the blocking structure, slides along the guide bump and flips until it lands on the receiving structure.

2. The medicine cutter with a blade protection and positioning structure according to claim 1, wherein the blocking structure comprises a blocking limit seat, a blocking limit portion is provided on the blocking limit seat, and the blocking limit portion is configured to be an arc shape; when the upper cover is opened and closed to a certain angle, one end of the blade protection cover contacts and abuts against the blocking limit portion.

3. The medicine cutter with a blade protection and positioning structure according to claim 2, wherein an upper end of the guide bump is configured to be an inclined state.

4. The medicine cutter with a blade protection and positioning structure according to claim 3, wherein the receiving structure comprises a receiving portion and a side end portion, one end of the side end portion is connected to the guide bump, and the other end thereof is connected to the receiving portion; an upper end of the receiving portion is configured to be an inclined state; when the upper cover rotates and closes on the lower cover, the blade protection cover abuts against the receiving portion.

5. The medicine cutter with a blade protection and positioning structure according to claim 4, wherein the blade protection cover comprises a first flipping connection portion, a second flipping connection portion, and a blade protection holder; the first flipping connection portion and the second flipping connection portion are both provided at an upper end of the blade protection holder, and one end of the first flipping connection portion and the second flipping connection portion are movably connected to the upper cover; the torsion spring is installed at the other end of the second flipping connection portion.

6. The medicine cutter with a blade protection and positioning structure according to claim 5, wherein the blade protection holder is in an “L” shape, and comprises a vertical protection portion and a horizontal protection portion; the first flipping connection portion and the second flipping connection portion are both connected to the vertical protection portion, and one end of the horizontal protection portion is provided with a limit end portion; when the upper cover is opened and closed at a certain angle, the limit end portion contacts and abuts against the blocking limit portion.

7. The medicine cutter with a blade protection and positioning structure according to claim 6, wherein the upper cover is further provided with a blade installation portion, a first flipping installation portion, and a second flipping installation portion; an upper end of the blade is fixedly installed in the blade installation portion, and the first flipping installation portion and the second flipping installation portion are both located on one side of the blade installation portion; one end of the first flipping connection portion is movably connected to the first flipping installation portion, and one end of the second flipping connection portion is fixedly connected to the second flipping connection portion.
